(19) United States
(12) Patent Application Publication
(10) Pub. No.: US 2025/0304063 A1
(43) Pub. Date: Oct. 2, 2025

(54) STORAGE MEDIUM, VEHICLE CONTROL DEVICE, AND VEHICLE CONTROL METHOD

(71) Applicant: HONDA MOTOR CO., LTD., Tokyo (JP)

(72) Inventors: Daisuke Nakanishi, Tokyo (JP); Haruhiko Nishiguchi, Tokyo (JP); Naito Suzuki, Tokyo (JP)

(21) Appl. No.: 19/059,338

(22) Filed: Feb. 21, 2025

(30) Foreign Application Priority Data
Mar. 29, 2024 (JP) 2024-055382

(51) Int. Cl. B60W 30/14

(52) U.S. Cl. CPC B60W 30/143; B60W 2520/105; B60W 2540/223; B60W 2552/30

(57) ABSTRACT

A storage medium of an embodiment is a non-transitory storage medium storing computer-readable instructions for causing a computer to execute the instructions. The instructions include: recognizing a surrounding situation of an own vehicle; detecting an acceleration operation of the own vehicle performed by a driver of the own vehicle; detecting contact of the driver with a steering operator that performs a steering operation of the own vehicle; generating a target trajectory and a target speed of the own vehicle on the basis of the surrounding situation; and executing driving control based on steering control of the own vehicle with respect to the generated target trajectory and speed control of the own vehicle with respect to the generated target speed, wherein the driving control includes a driving state in which the driver needs to be in contact with the steering operator and a driving state in which the driver does not need to be in contact with the steering operator, and wherein the instructions further include: permitting acceleration of the own vehicle in the driving state until a speed of the own vehicle is greater than a speed threshold value in a case in which the driving state is a driving state in which the driver does not need to be in contact with the steering operator, the acceleration operation of the driver is detected, and the speed of the own vehicle is less than or equal to the speed threshold value; and suppressing acceleration of the own vehicle and requesting the driver to come into contact with the steering operator until contact of the driver with the steering operator is detected in a case in which the driving state is a driving state in which the driver does not need to be in contact with the steering operator, the acceleration operation of the driver is detected, and the speed of the own vehicle is greater than the speed threshold value.

### CROSS-REFERENCE TO RELATED APPLICATION

This application is based upon and claims the benefit of priority from Japanese Patent Application No. 2024-055382, filed Mar. 29, 2024, the entire content of which is incorporated herein by reference.

### BACKGROUND

### Field of the Invention

The present invention relates to a storage medium, a vehicle control device, and a vehicle control method.

### Description of Related Art

In recent years, efforts to provide access to sustainable transportation systems that consider vulnerable people among transportation participants have intensified. In order to achieve this, research and development is focusing on further improving the safety and convenience of traffic through the research and development of driving assistance technologies. In relation to this, in recent years, technology in which traveling control is performed by imposing restrictions on a user requested driving force in a case in which the user requested driving force exceeds a system requested driving force in a state in which a user is not in contact with an operator and traveling control is performed without imposing restrictions on the user requested driving force in a case in which the user requested driving force exceeds the system requested driving force in a state in which the user is in contact with the operator has been disclosed (see, for example, Japanese Unexamined Patent Application, First Publication No. 2020-104759).

### SUMMARY

However, in driving assistance technology, the details of driving control according to the driving situation of the driver and the situation of the vehicle have not been considered, and there is a problem that appropriate driving control according to the situation, or the like may not be possible.

In order to solve the above-mentioned problems, an object of the present application is to provide a storage medium, a vehicle control device, and a vehicle control method that can perform more appropriate driving control according to the driving situation of the driver and the situation of the vehicle. Furthermore, the object of the present invention is to contribute to the development of sustainable transportation systems.

A storage medium, a vehicle control device, and a vehicle control method according to the present invention employ the following configurations.
(1) An aspect of the present invention is a non-transitory storage medium storing computer-readable instructions for causing a computer to execute the instructions. The instructions include: recognizing a surrounding situation of an own vehicle; detecting an acceleration operation of the own vehicle performed by a driver of the own vehicle; detecting contact of the driver with a steering operator that performs a steering operation of the own vehicle; generating a target trajectory and a target speed of the own vehicle on the basis of the surrounding situation; and executing driving control based on steering control of the own vehicle with respect to the generated target trajectory and speed control of the own vehicle with respect to the generated target speed, wherein the driving control includes a driving state in which the driver needs to be in contact with the steering operator and a driving state in which the driver does not need to be in contact with the steering operator, and wherein the instructions further include: permitting acceleration of the own vehicle in the driving state until a speed of the own vehicle is greater than a speed threshold value in a case in which the driving state is a driving state in which the driver does not need to be in contact with the steering operator, the acceleration operation of the driver is detected, and the speed of the own vehicle is less than or equal to the speed threshold value; and suppressing acceleration of the own vehicle and requesting the driver to come into contact with the steering operator until contact of the driver with the steering operator is detected in a case in which the driving state is a driving state in which the driver does not need to be in contact with the steering operator, the acceleration operation of the driver is detected, and the speed of the own vehicle is greater than the speed threshold value.
(2) In the above aspect (1), the instructions further include executing the driving control in the driving state in which the driver needs to be in contact with the steering operator in a case in which contact of the driver with the steering operator is detected within a predetermined time after the driver is requested to come into contact with the steering operator.
(3) In the above aspect (2), the instructions further include terminating the driving control in a case in which contact of the driver with the steering operator is detected after the predetermined time has elapsed.
(4) In the above aspect (1), the instructions further include: permitting acceleration of the own vehicle due to the acceleration operation of the driver in a case in which acceleration of the own vehicle due to the acceleration operation of the driver is less than or equal to an acceleration threshold value; and suppressing acceleration of the own vehicle due to the acceleration operation of the driver and requesting the driver to come into contact with the steering operator in a case in which acceleration of the own vehicle due to the acceleration operation of the driver is not less than or equal to the acceleration threshold value.
(5) In the above aspect (4), the acceleration threshold value is set to a smaller value as the speed of the own vehicle increases.
(6) In the above aspect (4), the acceleration threshold value is set to a constant value in a case in which the speed of the own vehicle is greater than a predetermined speed.
(7) In the above aspect (1), the instructions further include making the speed threshold value different between a case in which the own vehicle travels on a curved road and a case in which the own vehicle does not travel on the curved road.
(8) In the above aspect (7), in a case in which the own vehicle travels on the curved road, the speed threshold value is set to a speed that does not exceed a lateral acceleration upper limit value.
(9) In the above aspect (1), the instructions further include: accelerating the own vehicle due to the acceleration operation of the driver in a case in which contact of the driver with the steering operator is detected; and not suppressing acceleration of the own vehicle even in a case in which the speed of the own vehicle is greater than the speed threshold value.
(10) In the above aspect (7), the instructions further include generating the target speed on the basis of information about the curved road obtained from map information in a case in which the own vehicle travels at a position that is a predetermined distance or more before the curved road.
(11) In the above aspect (7), the instructions further include generating the target speed on the basis of information about the curved road obtained from output information from an external environment detection device mounted on the own vehicle in a case in which the own vehicle travels on the curved road.
(12) In the above aspect (1), the speed threshold value includes a first speed threshold value in a case in which the driver is in contact with the steering operator and a second speed threshold value in a case in which the driver is not in contact with the steering operator, and the instructions further include: permitting acceleration of the own vehicle in the driving state until the speed of the own vehicle is greater than the second speed threshold value in a case in which the driving state is a driving state in which the driver does not need to be in contact with the steering operator, the acceleration operation of the driver is detected, and the speed of the own vehicle is less than or equal to the second speed threshold value; and suppressing acceleration of the own vehicle and requesting the driver to come into contact with the steering operator until contact of the driver with the steering operator is detected in a case in which the driving state is a driving state in which the driver does not need to be in contact with the steering operator, the acceleration operation of the driver is detected, and the speed of the own vehicle is greater than the second speed threshold value.
(13) Another aspect of the present invention is a vehicle control device including: a recognition unit that recognizes a surrounding situation of an own vehicle; an acceleration detection unit that detects an acceleration operation of the own vehicle performed by a driver of the own vehicle; a steering detection unit that detects contact of the driver with a steering operator that performs a steering operation of the own vehicle; and a driving control unit that generates a target trajectory and a target speed of the own vehicle on the basis of the surrounding situation, and executes driving control based on steering control of the own vehicle with respect to the generated target trajectory and speed control of the own vehicle with respect to the generated target speed, wherein the driving control includes a driving state in which the driver needs to be in contact with the steering operator and a driving state in which the driver does not need to be in contact with the steering operator, wherein the driving control unit permits acceleration of the own vehicle in the driving state until a speed of the own vehicle is greater than a speed threshold value in a case in which the driving state is a driving state in which the driver does not need to be in contact with the steering operator, the acceleration operation of the driver is detected by the acceleration detection unit, and the speed of the own vehicle is less than or equal to the speed threshold value, and wherein the driving control unit suppresses acceleration of the own vehicle and requests the driver to come into contact with the steering operator until contact of the driver with the steering operator is detected in a case in which the driving state is a driving state in which the driver does not need to be in contact with the steering operator, the acceleration operation of the driver is detected by the acceleration detection unit, and the speed of the own vehicle is greater than the speed threshold value.
(14) Still another aspect of the present invention is a vehicle control method causing a computer to: recognize a surrounding situation of an own vehicle; detect an acceleration operation of the own vehicle performed by a driver of the own vehicle; detect contact of the driver with a steering operator that performs a steering operation of the own vehicle; generate a target trajectory and a target speed of the own vehicle on the basis of the surrounding situation; execute driving control based on steering control of the own vehicle with respect to the generated target trajectory and speed control of the own vehicle with respect to the generated target speed, wherein the driving control includes a driving state in which the driver needs to be in contact with the steering operator and a driving state in which the driver does not need to be in contact with the steering operator, and wherein the method causes the computer further to: permit acceleration of the own vehicle in the driving state until a speed of the own vehicle is greater than a speed threshold value in a case in which the driving state is a driving state in which the driver does not need to be in contact with the steering operator, the acceleration operation of the driver is detected, and the speed of the own vehicle is less than or equal to the speed threshold value; and suppress acceleration of the own vehicle and request the driver to come into contact with the steering operator until contact of the driver with the steering operator is detected in a case in which the driving state is a driving state in which the driver does not need to be in contact with the steering operator, the acceleration operation of the driver is detected, and the speed of the own vehicle is greater than the speed threshold value.

According to the above aspects (1) to (14), it is possible to perform more appropriate driving control according to the driving situation of the driver and the situation of the vehicle.

### BRIEF DESCRIPTION OF THE DRAWINGS

FIG. 1 is a configuration diagram of an own vehicle on which a vehicle control device according to an embodiment is mounted.

FIG. 2 is a diagram showing an example of driving control of the related art.

FIG. 3 is a diagram for explaining a transition of a driving state in the embodiment.

FIG. 4 is a diagram showing examples of transition conditions of a driving state.

FIG. 5 is a diagram for explaining acceleration control in a hands-off state.

FIG. 6 is a diagram for explaining a transition of a driving state when traveling near a curved road.

FIG. 7 is a flowchart showing an example of processing executed by a driving assistance device according to the embodiment.

### DESCRIPTION OF EMBODIMENTS

Hereinafter, embodiments of a storage medium, a vehicle control device, and a vehicle control method of the present invention will be described with reference to the drawings.

### Overall Configuration

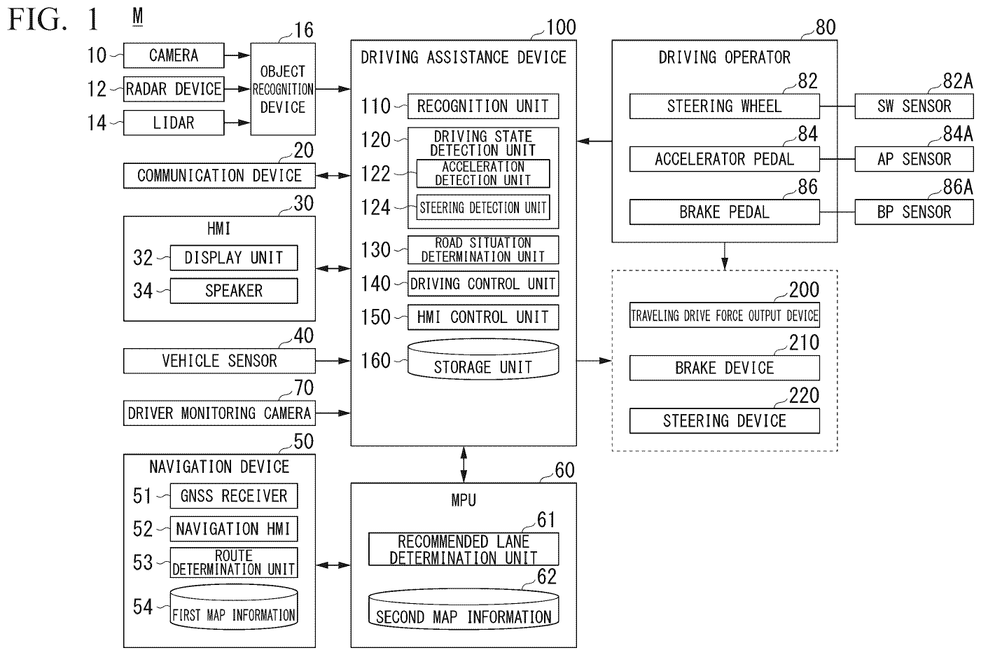

FIG. 1 is a configuration diagram of an own vehicle M on which a vehicle control device according to an embodiment is mounted. The own vehicle M is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination of these. The electric motor operates using the electric power generated by a generator connected to an internal combustion engine or the electric power discharged from a secondary battery or a fuel cell.

The own vehicle M is equipped with, for example, a camera 10, a radar device 12, a light detection and ranging (LIDAR) 14, an object recognition device 16, a communication device 20, a human machine interface (HMI) 30, and a vehicle sensor 40, a navigation device 50, a map positioning unit (MPU) 60, a driver monitoring camera 70, an driving operator 80, a driving assistance device 100, a traveling drive force output device 200, a brake device 210, and a steering device 220. These devices and instruments are connected to each other by a multiplex communication line such as a controller area network (CAN) communication line, a serial communication line, a wireless communication network, or the like. A configuration shown in FIG. 1 is merely an example, and some of the configuration may be omitted or another configuration may be added. The HMI 30 is an example of a “notification unit.” The driving assistance device 100 is an example of a “vehicle control device.”

The camera 10 is, for example, a digital camera that uses a solid-state imaging sensor such as a charge coupled device (CCD) or a complementary metal oxide semiconductor (CMOS). The camera 10 is attached to an arbitrary location on the own vehicle M. In a case in which the forward portion is imaged, the camera 10 is attached to an upper portion of a front windshield, a back surface of a rearview mirror, and the like. The camera 10 periodically and repeatedly images the surroundings of the own vehicle M, for example. The camera 10 may be a stereo camera.

The radar device 12 radiates radio waves such as millimeter waves near the own vehicle M and detects the radio waves (reflected waves) reflected by an object to detect at least the position (the distance and direction) of the object. The radar device 12 is attached to an arbitrary location on the own vehicle M. The radar device 12 may detect the position and the speed of the object by a frequency modulated continuous wave (FM-CW) method.

The LIDAR 14 irradiates the surroundings of the own vehicle M with light (or electromagnetic waves having a wavelength close to that of light) and measures the scattered light. The LIDAR 14 detects a distance to a target on the basis of a time from light emission to light reception. The emitted light is, for example, a pulsed laser beam. The LIDAR 14 is attached to an arbitrary location on the own vehicle M.

The object recognition device 16 performs sensor fusion processing on detection results obtained by some or all of the camera 10, the radar device 12, and the LIDAR 14 and recognizes the position, the type, the speed, and the like of the object. The object recognition device 16 outputs the recognition result to the driving assistance device 100. The object recognition device 16 may output the detection results of the camera 10, the radar device 12, and the LIDAR 14 to the driving assistance device 100 as they are. The object recognition device 16 may be omitted from the own vehicle M. Some or all of the camera 10, the radar device 12, the LIDAR 14, and the object recognition device 16 are examples of “external environment detection devices.”

The communication device 20 communicates with another vehicle near the own vehicle M using, for example, networks such as a cellular network, a Wi-Fi network, Bluetooth (registered trademark), and dedicated short range communication (DSRC) or communicates with various server devices via a radio base station.

The HMI 30 presents various items of information to the occupant of the own vehicle M and also accepts input operations performed by the occupant. The HMI 30 includes, for example, a display unit 32 and a speaker 34. The display unit 32 is, for example, an LCD (liquid crystal display) or an organic EL (electro luminescence) display device. The display unit 32 displays various images (including videos) in the embodiment. The display unit 32 may be integrated with an input unit as a touch panel. The speaker 34 outputs a predetermined sound (for example, an alarm, or the like). In addition, the HMI 30 may be a microphone, a buzzer, a vibration generating device (a vibrator), a touch panel, a switch, a key, or the like, in addition to (or instead of) the display unit 32 and the speaker 34. For example, the HMI 30 may include a changeover switch that changes the driving state of the own vehicle M, which will be described below, by the operation of the driver.

The vehicle sensor 40 includes a vehicle speed sensor that detects the speed of the own vehicle M, an acceleration sensor that detects the acceleration, a yaw rate sensor that detects the yaw rate (for example, the rotational angular velocity around a vertical axis passing through the center of gravity of the own vehicle M), a lateral acceleration sensor (a lateral G sensor) that detects the lateral acceleration (lateral G) of the own vehicle M, a direction sensor that detects the direction of the own vehicle M, and a steering angle sensor that detects the steering angle of the own vehicle M (which may be the angle of the steering wheel or the operating angle of the steering wheel). In addition, the vehicle sensor 40 may be provided with a position sensor that detects the position of the own vehicle M. The position sensor is, for example, a sensor that acquires position information (longitude and latitude information) from a global positioning system (GPS) device. In addition, the position sensor may also be a sensor that acquires position information using a global navigation satellite system (GNSS) receiver 51 of the navigation device 50.

The navigation device 50 includes, for example, the GNSS receiver 51, a navigation HMI 52, and a route determination unit 53. The navigation device 50 holds first map information 54 in a storage device such as a hard disk drive (HDD) or a flash memory. The GNSS receiver 51 identifies the position of the own vehicle M on the basis of a signal received from GNSS satellites. The position of the own vehicle M may be specified or complemented by an inertial navigation system (INS) using an output from the vehicle sensor 40. The navigation HMI 52 includes a display device, a speaker, a touch panel, a key, and the like. The navigation HMI 52 may be partially or wholly shared with the above-mentioned HMI 30. For example, the route determination unit 53 determines a route from a position of the own vehicle M specified by the GNSS receiver 51 (or an arbitrary input position) to a destination input by the occupant using the navigation HMI 52 (hereinafter referred to as a route on a map) with reference to the first map information 54. The first map information 54 is, for example, information in which a road shape is expressed with a link indicating a road and a node connected through the link. The first map information 54 may include point of interest (POI) information, and the like. The route on the map is output to the MPU 60. The navigation device 50 may perform route guidance using the navigation HMI 52 on the basis of the route on the map. The navigation device 50 may be realized by, for example, the function of a terminal device such as a smartphone or a tablet terminal owned by the occupant. The navigation device 50 may transmit a current position and a destination to a navigation server via the communication device 20 and acquire a route equivalent to the route on the map from the navigation server.

The MPU 60 includes, for example, a recommended lane determination unit 61 and holds second map information 62 in a storage device such as an HDD or a flash memory. The recommended lane determination unit 61 divides the route on the map provided by the navigation device 50 into a plurality of blocks (for example, divides the route into 100 [m] units in a vehicle traveling direction) and determines a recommended lane for each block while referring to the second map information 62. The recommended lane determination unit 61 determines which lane from the left the vehicle travels in. In addition, in a case where a branch location is present on the route on the map, the recommended lane determination unit 61 determines the recommended lane such that the own vehicle M can travel on a reasonable route to proceed to a branch destination. The second map information 62 is map information having higher accuracy than the first map information 54. The second map information 62 includes, for example, information on the center of a lane, lane boundary information such as a road dividing line that marks a lane (hereinafter referred to as a lane marking line), or the like. In addition, the second map information 62 may include road information such as the radius of curvature (or the curvature), the gradient, and the width of the road (or of each lane included in the road), traffic regulation information, address information (an address and a postal code), facility information, telephone number information, and the like. The second map information 62 may be updated at any time through the communication device 20 communicating with another device. In addition, the first map information 54 and the second map information 62 may be stored in a storage unit within the driving assistance device 100.

The driver monitoring camera 70 is a digital camera that uses, for example, a solid-state image sensor such as a CCD or CMOS. The driver monitoring camera 70 is attached at any location on the own vehicle M in a position and a direction that allow it to capture an image of the head and the upper body (including the positions of the hands) of the driver seated in the driver's seat of the own vehicle M from the front (in a direction in which an image of the face is captured). For example, the driver monitoring camera 70 is attached to the upper portion of a display device provided in the central portion of the instrument panel of the own vehicle M. The driver monitoring camera 70 captures an image of the interior of the vehicle compartment including the driver of the own vehicle M from its installed position and outputs the image to the driving assistance device 100.

The driving operator 80 includes, for example, a steering wheel 82, an accelerator pedal 84, a brake pedal 86, an operation switch of a turn signal, a shift lever, and other operators. A sensor for detecting the amount of operation or the presence or absence of the operation is attached to the driving operator 80, and the detection results thereof are output to the driving assistance device 100 or some or all of the traveling drive force output device 200, the brake device 210, and the steering device 220. The steering wheel 82 is an example of a “steering operator.”

For example, the steering wheel 82 is provided with a steering wheel sensor (a SW sensor) 82A. The SW sensor 82A detects whether or not the driver is in contact with the steering wheel 82. In addition, the SW sensor 82A may detect whether or not the driver is gripping the steering wheel 82, and may detect the amount of operation of the steering wheel 82 performed by the driver (the amount of steer torque, the amount of steering). The steering wheel 82 does not necessarily have to be annular and may be in a form of a modified steering wheel, a joystick, a button, or the like. In this case, the SW sensor 82A detects the amount of operation according to each form.

The accelerator pedal 84 is provided with an accelerator pedal sensor (AP sensor) 84A. The AP sensor 84A detects the amount of operation of the accelerator pedal 84 (the opening degree), which changes according to the operation of the driver on the accelerator pedal 84 (hereinafter referred to as an AP operation). The brake pedal 86 is provided with a brake pedal sensor (BP sensor) 86A. The BP sensor 86A detects the amount of operation of the brake pedal 86 (opening degree), which changes according to the operation of the driver on the brake pedal 86 (hereinafter referred to as a BP operation).

The traveling drive force output device 200 outputs a traveling drive force (torque) for the own vehicle M to travel to a drive wheel. The traveling drive force output device 200 includes, for example, a combination of an internal combustion engine, an electric motor, a transmission, and the like and an electronic control unit (ECU) that controls them. The ECU controls the above configuration according to the information input from the driving assistance device 100 or the information input from the driving operator 80.

The brake device 210 includes, for example, a brake caliper, a cylinder that transmits hydraulic pressure to the brake caliper, an electric motor that generates the hydraulic pressure in the cylinder, and an ECU. The ECU controls the electric motor according to the information input from the driving assistance device 100 or the information input from the driving operator 80 such that brake torque corresponding to a braking operation is output to each wheel. The brake device 210 may include a mechanism for transmitting the hydraulic pressure generated by the operation of the brake pedal included in the driving operator 80 to the cylinder via a master cylinder as a backup. The brake device 210 is not limited to the configuration described above and may be an electronically controlled hydraulic brake device that controls an actuator according to the information input from the driving assistance device 100 and transmits the hydraulic pressure of the master cylinder to the cylinder.

The steering device 220 includes, for example, a steering ECU and an electric motor. The electric motor applies a force to a rack and pinion mechanism to change the direction of a turning wheel, for example. The steering ECU drives the electric motor according to the information input from the driving assistance device 100 or the information input from the driving operator 80 and changes the direction of the turning wheel.

### Driving Assistance Device

The driving assistance device 100 includes, for example, a recognition unit 110, a driving state detection unit 120, a road situation determination unit 130, a driving control unit 140, an HMI control unit 150, and a storage unit 160. The recognition unit 110, the driving state detection unit 120, the road situation determination unit 130, the driving control unit 140, and the HMI control unit 150 are realized by, for example, a hardware processor such as a central processing unit (CPU) executing a program (software). In addition, some or all of these components may be realized by hardware (a circuit unit: including circuitry) such as a large scale integration (LSI), an application specific integrated circuit (ASIC), a field-programmable gate array (FPGA), a graphics processing unit (GPU), or a system on chip (SOC), or may be realized by software and hardware in cooperation. The program may be stored in advance in a storage device (a storage device including a non-transitory storage medium) such as an HDD or a flash memory of the driving assistance device 100, or may be stored in an attachable and detachable storage medium such as a DVD or a CD-ROM. In the latter case, the storage medium (the non-transitory storage medium) may be mounted on a drive device, and thus the program may be installed in an HDD or a flash memory of the driving assistance device 100. The HMI control unit 150 is an example of a “notification control unit.”

For example, settings are made within the traveling drive force output device 200, the brake device 210, and the steering device 220 such that instructions from the driving assistance device 100 to the traveling drive force output device 200, the brake device 210, and the steering device 220 are executed with priority over the detection results from the driving operator 80. With respect to braking, in a case in which the braking force based on the operation amount of the brake pedal 86 is greater than the instructions from the driving assistance device 100, it may be set such that the latter is executed with priority. In addition, as a mechanism for executing instructions from the driving assistance device 100 with priority, communication priority in an in-vehicle local area network (LAN) may be used.

The storage unit 160 may be realized by any of the various storage devices described above, a solid state drive (SSD), an electrically erasable programmable read only memory (EEPROM), a read only memory (ROM), a random access memory (RAM), or the like. The storage unit 160 stores, for example, a program and various other items of information. In addition, the storage unit 160 may also store the above-mentioned map information (the first map information 54, the second map information 62).

The recognition unit 110 recognizes a surrounding situation of the own vehicle M on the basis of information input from the external environment detection devices. For example, the recognition unit 110 recognizes the states such as the position, the speed, and the acceleration of an object present in the vicinity (for example, within a predetermined distance from the own vehicle M). The object may be, for example, another vehicle, a bicycle, a walker, or the like. The position of the object is recognized as, for example, a position on absolute coordinates with a representative point (the center of gravity, the center of a drive axis, or the like) of the own vehicle M set as the origin and is used for control. The position of the object may be represented by a representative point such as the center of gravity or a corner of the object, or may be represented by a region. The “state” of the object may include the acceleration, the jerk, or the “behavioral state” (for example, whether or not it is changing lanes or is about to change lanes) of the object. In addition, the recognition unit 110 recognizes the relative position and relative speed of the object.

In addition, the recognition unit 110 recognizes, for example, a lane (a traveling lane) in which the own vehicle M is traveling. For example, the recognition unit 110 performs known analysis processing (for example, edge extraction, feature extraction, pattern matching processing, or the like) on an image captured by the camera 10 (hereinafter referred to as a camera image), and recognizes the positions and patterns of the lane marking lines (for example, an arrangement of solid lines and dashed lines) around the own vehicle M from the analysis results. In addition, the recognition unit 110 may refer to the map information (the second map information 62) on the basis of the position information of the own vehicle M and recognize the positions and patterns of the lane marking lines around the vehicle M. In addition, the recognition unit 110 may recognize the traveling lane using at least one of the positions and patterns of the lane marking lines obtained from the camera image and the positions and patterns of the lane marking lines obtained from the map information. The recognition unit 110 may recognize the traveling lane by recognizing a traveling road boundary (a road boundary) including a road shoulder, a curb, a median strip, a guardrail, and the like, as well as the lane marking lines. In this recognition, the position of the own vehicle M acquired from the navigation device 50 and the processing results by the INS may be taken into account. In addition, the recognition unit 110 may also recognize adjacent lanes adjacent to the traveling lane. In addition, the recognition unit 110 may recognize the radius of curvature (or the curvature), gradient, width, and the like of the traveling lane (or the road) from at least one of the camera image and the map information. In addition, the recognition unit 110 also recognizes an obstacle, a stop line, a red light, a tollgate, and other road events from the recognition results for the object. The obstacle is an object with which the own vehicle M needs to avoid contact, and includes, for example, another vehicle or the like.

In addition, the recognition unit 110 may also recognize the position and posture of the own vehicle M with respect to the traveling lane. The recognition unit 110 may recognize, for example, a deviation of a reference point of the own vehicle M from the center of the lane and an angle formed between the traveling direction of the own vehicle M and a line along the center of the lane as a relative position and a posture of the own vehicle M with respect to the traveling lane. The recognition unit 110 may recognize the position of the reference point of the own vehicle M with respect to any side end portion (a road dividing line or a road boundary) of the traveling lane as the relative position of the own vehicle M with respect to the traveling lane, instead of these. In addition, the recognition unit 110 may recognize the position and posture of another vehicle traveling in the traveling lane of the own vehicle M, or may recognize whether another vehicle is present in the center side of the traveling lane or is present on a side of the lane marking line as seen from the own vehicle M.

The driving state detection unit 120 detects the driving state of the own vehicle M. The driving state includes the driving state of the own vehicle M obtained by the operation of the driver and the driving state of the own vehicle M obtained by the control performed by the driving control unit 140 (the automatic driving control). The driving state detection unit 120 includes, for example, an acceleration detection unit 122 and a steering detection unit 124. The acceleration detection unit 122 detects an acceleration operation of the own vehicle M performed by the driver. For example, the acceleration detection unit 122 detects the AP operation of the driver or detects the amount of operation of the accelerator pedal 84 (the opening degree) on the basis of the detection results obtained by the AP sensor 84A. The steering detection unit 124 detects whether or not the driver is in contact with the steering wheel 82 (presence or absence of contact) on the basis of, for example, the detection results of the SW sensor 82A. In addition, the steering detection unit 124 detects the steering amount (the torque amount of steering torque) caused by the operation of the driver on the steering wheel 82 (the steering operation). The driving state detection unit 120 may detect the BP operation of the driver or may detect the amount of operation of the brake pedal 86 (the opening degree) on the basis of the detection results of the BP sensor 86A. In addition, the driving state detection unit 120 may detect a state in which the driver is not performing any driving operation (a state in which the driver is not in contact with the driving operator 80).

In addition, the driving state detection unit 120 may detect whether or not the driver is in a predetermined state on the basis of the image captured by the driver monitoring camera 70. The predetermined state is a hands-off state or a hands-on state. The hands-off state is a state in which the driver is not in contact with (is not gripping) the steering wheel 82, and the hands-on state is a state in which the driver is in contact with (is gripping) the steering wheel 82. Whether the driver is in the hands-on state or the hands-off state may be determined on the basis of, for example, the results of detection of the driver's contact with the steering wheel 82 obtained by the SW sensor 82A. In addition, the predetermined state may be a state in which the driver is monitoring the forward portion (or the surroundings of the own vehicle M), or a state in which the driving control of the system of the own vehicle M (automatic driving) can be quickly handed over to manual driving performed by the driver. The fact that the driver monitors the forward portion means, for example, that the driver's line of sight is directed forward.

In addition, the driving state detection unit 120 may detect the speed, lateral G, and acceleration caused by the driver performing the steering operation or the AP operation on the basis of the detection results obtained by the vehicle sensor 40.

The road situation determination unit 130 determines the situation of the road on which the own vehicle M is traveling. For example, the road situation determination unit 130 determines whether or not a curved road is present within a predetermined distance in the traveling direction of the own vehicle M on the basis of the surrounding situation recognized by the recognition unit 110 from the external environment detection device or the like such as the camera 10. For example, the road situation determination unit 130 determines that a curved road is present in a case in which the radius of curvature of the traveling lane within a predetermined distance in the traveling direction is less than a threshold value. In addition, the road situation determination unit 130 may obtain the road situation (the radius of curvature) of the own vehicle M by referring to the map information on the basis of the position information of the own vehicle M obtained by the vehicle sensor 40, and determine whether or not a curved road is present within a predetermined distance in the traveling direction of the own vehicle M, instead of (or in addition to) determining whether a curved road is present using the external environment detection device. In addition, in determining whether the road is a curve, the road situation determination unit 130 may use the curvature instead of the radius of curvature. In addition, the road situation determination unit 130 may determine whether or not the traveling lane in the traveling direction of the own vehicle M is a straight line on the basis of the radius of curvature or the curvature.

The driving control unit 140 performs driving control (automatic driving) to control at least one of the steering and the speed of the own vehicle M on the basis of the surrounding situation of the own vehicle M recognized by the recognition unit 110. For example, the driving control unit 140 performs lane keeping control (LKAS: Lane Keeping Assistance System) of the own vehicle M such that a reference point (for example, the center of gravity or the center) of the own vehicle M is positioned in the center of the traveling lane of the own vehicle M on the basis of the surrounding situation recognized by the recognition unit 110, the driver instructions, or the like. In LKAS control, for example, in a case in which the driver is in the hands-on state and the steering direction based on the steering torque applied to the steering wheel 82 is a direction that would cause the own vehicle M to deviate from the center of the lane (or the traveling lane), a reaction force may be applied to the steering operation in that direction to perform control for suppressing deviation from the center of the lane (or the traveling lane).

In addition, the driving control unit 140 may perform an adaptive cruise control system (ACC) control that drives the vehicle at a constant speed (a set vehicle speed in advance) in the traveling lane on the basis of the surrounding situation. In the ACC control, for example, in a case in which the distance between the vehicle M and the preceding vehicle becomes within a predetermined distance, control that automatically performs acceleration and deceleration and performs following traveling while keeping a predetermined inter-vehicle distance is performed, and in a case in which the preceding vehicle is no longer present due to a lane change or the like, control that automatically accelerates the own vehicle M to a set speed is performed. In addition, the driving control unit 140 may execute various driving controls such as auto lane change assist (ALCA) control that assists the own vehicle M in changing lanes from the traveling lane to an adjacent lane, collision mitigation brake system (CMBS) control that warns the driver in a case in which there is a possibility of contact with an obstacle to perform the brake control of the own vehicle M, traffic jam pilot (TJP) control that maintains an inter-vehicle distance to travel while adapting to changes in the vehicle speed of the preceding vehicle when traveling at a low speed such as in a traffic jam, and emergency stop control that stops the own vehicle M in a safe position.

In addition, the driving control unit 140 executes the driving control so as to achieve a predetermined driving state according to the detection results obtained by the driving state detection unit 120 and the road situation determined by the road situation determination unit 130. The driving state may include, for example, at least some of the various driving controls described above, and may include control regarding notification to request the driver to perform a predetermined driving operation (for example, to be in the hands-on state), control to suppress acceleration due to the AP operation, and the like. In addition, the driving state may include terminating the driving control and allowing the driver to execute the manual driving. In addition, the driving state may include a driving state in which the driver needs to be in contact with the steering wheel 82 and a driving state in which the driver does not need to be come into contact with the steering wheel 82.

For example, the driving control unit 140 generates a target trajectory and a target speed for the own vehicle M according to the driving state on the basis of the content of the driving state to be executed and the surrounding situation of the own vehicle M, and executes steering control of the own vehicle M with respect to the generated target trajectory and speed control of the own vehicle M with respect to the generated target speed. In addition, the driving control unit 140 outputs a notification instruction to the HMI control unit 150 to request the driver to perform a predetermined driving operation according to the driving state. The functions of the driving control unit 140 will be described in detail below.

The HMI control unit 150 notifies the occupant (including the driver) of predetermined information via the HMI 30. The predetermined information includes, for example, information related to the traveling of the own vehicle M, such as information regarding the state of the own vehicle M and information regarding the driving control. The information regarding the state of the own vehicle M includes, for example, the speed, the engine speed, the shift position of the own vehicle M, and the like. In addition, the information regarding the driving control includes, for example, the type of the driving control (the driving state) executed, the reason for the operation of the driving control, the situation of the driving control, and information indicating that the driving control is started or terminated. In addition, the information regarding the driving control may include information regarding a request for the driver to perform a predetermined driving operation (for example, hands-on), a warning, and an alarm. In addition, the predetermined information may include information regarding the current location, the destination, and the remaining fuel level of the own vehicle M, or the like, and may include information unrelated to the traveling control of the own vehicle M, such as the television programs, the content (for example, movies) stored on the storage medium such as a DVD, or the like.

For example, the HMI control unit 150 may generate an image including the above-mentioned predetermined information and display the generated image on the display unit 32 of the HMI 30, or may generate a sound indicating the predetermined information and output the generated sound from the speaker 34 of the HMI 30. The timing at which the sound is output includes, for example, the timing at which the driving control is started or stopped, the timing at which the image displayed is switched when a call is received, the timing at which the own vehicle M is in a predetermined state, and the like. In addition, the HMI control unit 150 may output the information received from the HMI 30 to the driving control unit 140. In addition, on the basis of instruction information from the driving control unit 140, and the like, the HMI control unit 150 causes the HMI 30 to output information requesting the driver to perform a predetermined driving operation, and controls the timing of the start and termination of output of the information output by the HMI 30.

### Driving Control

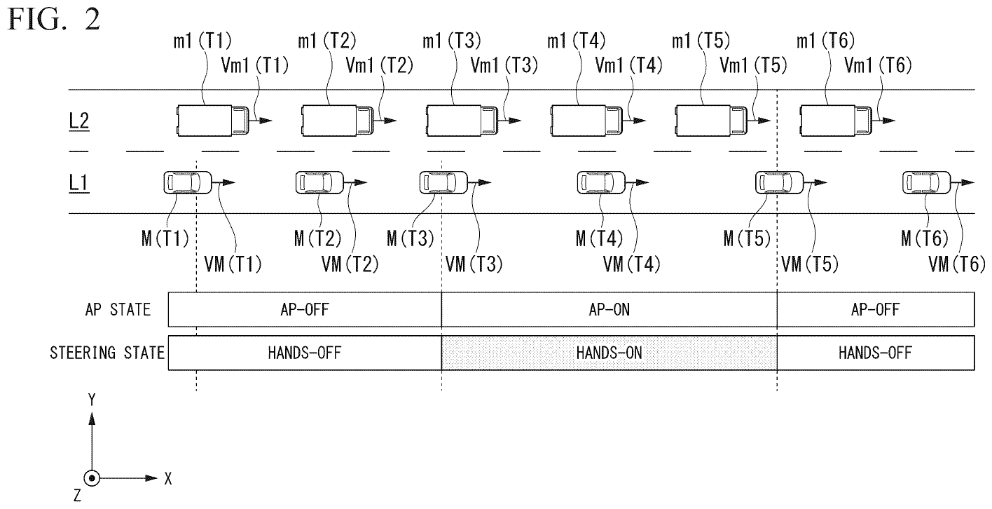

Here, before describing the details of the driving control according to the embodiment, an example of driving control of the related art will be described. FIG. 2 is a diagram showing the example of the driving control of the related art. In the example of FIG. 2, there are two lanes L1 and L2 that can be traveled in the same direction (an X-axis direction in the drawing), and the own vehicle M is traveling on the lane L1 at a speed VM, while another vehicle m1 is traveling on the lane L2, which is an adjacent lane to the lane L1, at a speed Vm1. In the example of FIG. 2, another vehicle m1 is shown as a truck, but the type of the vehicle is not limited to this. In addition, in the example of FIG. 2, at time T*, the reference position (for example, the center of gravity position) of the own vehicle M is represented as M (T*), the speed of the own vehicle M is represented as VM (T*), the reference position of another vehicle m1 is represented as m1 (T*), and the speed of another vehicle m1 is represented as Vm1 (T*). In addition, in the following description, it is assumed that time T1 is the earliest, followed by times T2, T3, T4, T5, and T6 in that order. In addition, the example of FIG. 2 shows the accelerator pedal state (AP state) and the steering state (hands-off/hands-on) over time.

In the example of FIG. 2, the ACC control is executed on the own vehicle M during the period from time T1 to time T3, and traveling at a constant speed is executed on the own vehicle M based on a preset set speed in a state in which the driver does not operate the accelerator pedal 84 (an AP-off state) and in the hands-off state. In addition, during the period from time T1 to time T3, the speed difference between the speed VM of the own vehicle M and the speed Vm1 of another vehicle m1 is small, and the own vehicle M and another vehicle m1 travel in parallel (travel with their lateral positions overlapping each other). In this situation, the driver of the own vehicle M performs the AP operation to temporarily accelerate the own vehicle M in order to shift the parallel-traveling position with another vehicle m1.

For example, in a case in which the driver performs the AP operation at time T3 (in the case of an AP-on state), in the driving control of the related art, the acceleration control is executed on the condition that the hands-off state is changed to the hands-on state. For this reason, during the period from time T3 to time T5, acceleration is executed in the hands-on state, and if the driver is in the AP-off state at time T5 when the lateral positions of the own vehicle M and another vehicle m1 are shifted, traveling at a constant speed based on the set speed is executed after that time (for example, time T6 or the like), and the own vehicle is allowed to be in the hands-off state. As described above, in the driving control of the related art, even in a case in which the own vehicle M is temporarily accelerated, the driver needs to be in the hands-on state, which places an operational burden on the driver. In addition, on the other hand, if acceleration is possible unconditionally in the hands-off state, there is a possibility that the speed and the acceleration become a speed and an acceleration which are unacceptable in the hands-off state, and safety could not be guaranteed. Therefore, in the present embodiment, even in a case in which the AP operation is performed in the hands-off state, a certain degree of acceleration is allowed according to the condition, thereby reducing the operational burden and improving operability while maintaining safety. Therefore, according to the present embodiment, it is possible to perform more appropriate driving control according to the driving situation of the driver and the situation of the vehicle.

Next, the details of the driving control according to the embodiment will be described. For example, the driving control unit 140 executes the driving control on the own vehicle M such that the own vehicle M is in a driving state that is set on the basis of the driving situation of the driver and the situation of the own vehicle M, from among a plurality of predetermined driving states. In addition, the driving control unit 140 transitions the executed driving state to another transition state according to a predetermined transition condition, or maintains (continues) the current driving state.

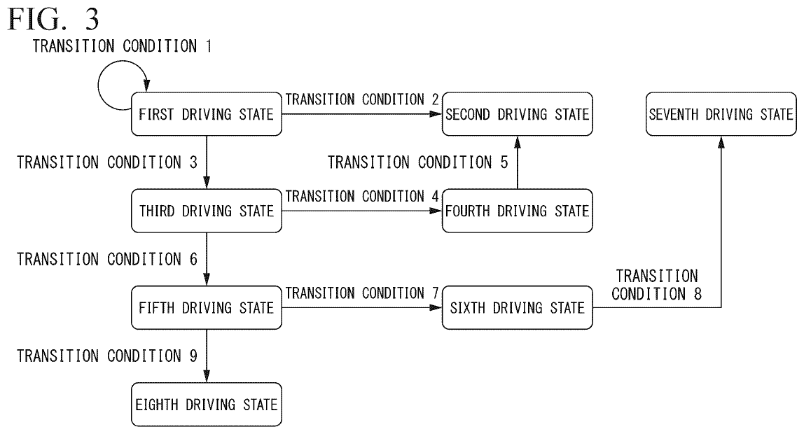

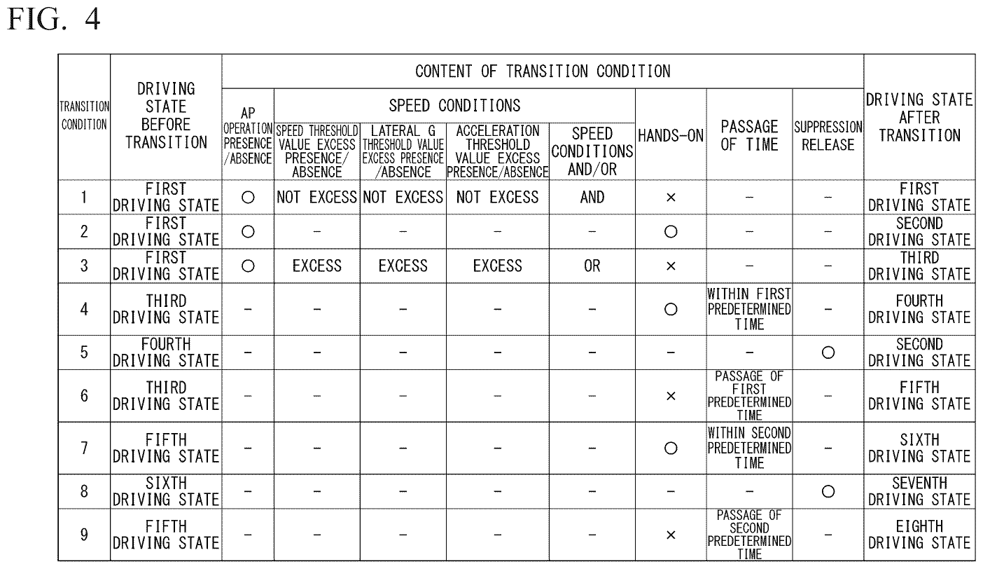

FIG. 3 is a diagram for explaining a transition of the driving state in the embodiment. In addition, FIG. 4 is a diagram showing examples of transition conditions of the driving state. In the example of FIG. 4, the driving state before the transition, the content of the transition condition, and the driving state after the transition are associated with each transition condition in association with the content of FIG. 3. The content of the transition condition includes, for example, information such as AP operation presence/absence, speed conditions of the own vehicle M, hands-on presence/absence, passage of time, and suppression release. The speed conditions include whether or not the speed based on the AP operation exceeds a speed threshold value (speed threshold value excess presence/absence), whether or not the lateral G (the lateral acceleration) on the own vehicle M (or the occupant) due to the AP operation exceeds a threshold value (a lateral G threshold value) (lateral G threshold value excess presence/absence), whether or not the acceleration due to the AP operation amount (the opening amount) exceeds an acceleration threshold value (acceleration threshold value excess presence/absence), and the like. In addition, the speed conditions may include information such as whether an AND condition or an OR condition of the various speed conditions described above is satisfied. In addition, in the item of the AP operation presence/absence in FIG. 4, “∘” indicates that the AP operation is performed, and “−” indicates that it does not matter whether the AP operation is performed or not. In addition, in the item of hands-on, “∘” indicates a hands-on state, “×” indicates no hands-on state (a hands-off state), and “−” indicates that it does not matter whether the hands-on is performed or not. In addition, in the item of the suppression release, “∘” indicates that suppression release is performed, and “−” indicates that it does not matter whether suppression release is performed or not. The information shown in FIG. 4 may be stored, for example, in the storage unit 160, or may be acquired from an external device via the communication device 20. Hereinafter, for each transition condition, the content of the condition and the driving state in a case in which the condition is satisfied will be specifically described with reference to FIG. 3 and FIG. 4.

### In the Case of Transition Condition 1

The driving state before the transition due to transition condition 1 is a first driving state. The first driving state is, for example, a state in which the driver is in the hands-off state and the LKAS control and the ACC control can be executed through the driving control (the automatic driving) of the driving control unit 140. The driving control in the first driving state is executed on the basis of, for example, the instruction from the driver or the surrounding situation. In the following, it is assumed that the first driving state is a state in which both the LKAS control and the ACC control are executed. In the first driving state, the driving control unit 140 generates, for example, a future target trajectory for the vehicle M to travel in the recommended lane determined by the recommended lane determination unit 61 on the basis of the surrounding situation of the own vehicle M, and a target speed based on a preset set speed (for example, a speed whose error from the set speed is within a threshold value), and executes the steering control of the own vehicle M with respect to the generated target trajectory and the speed control of the own vehicle M with respect to the generated target speed, thereby performing the LKAS control and the ACC control. For example, the target trajectory and the target speed are updated according to a change in the surrounding situation (for example, other vehicles in the vicinity and the road shape). In addition, the set speed may be set according to the type of the driving control or the driving state, or the surrounding situation, and may be adjustable by the operation of the driver.

Here, the condition of transition condition 1 is that, in a case in which the own vehicle M is in the first driving state, the AP operation (the acceleration operation) performed by the driver is detected in the hands-off state, and the speed conditions, that is, the speed VM, the lateral G, and acceleration of the own vehicle M due to the AP operation, do not all exceed the threshold value (AND condition). In a case in which the condition of transition condition 1 is satisfied, the driving control unit 140 performs control to maintain (continue) the current state (the first driving state) of the own vehicle M (does not transition to another driving state). By maintaining the first driving state, for example, acceleration of the own vehicle M is permitted until the speed VM of the own vehicle M is greater than the speed threshold value through the AP operation.

### In the Case of Transition Condition 2

Transition condition 2 is that, in a case in which the own vehicle M is in the first driving state, the AP operation of the driver is detected and the driver is in the hands-on state. Transition condition 2 does not include the speed conditions. In a case in which the condition of transition condition 2 is satisfied, the driving control unit 140 transitions the own vehicle M from the first driving state to a second driving state. The second driving state is, for example, a state in which the driver is in the hands-on state and the LKAS control or the like is executed by the driving control unit 140. In addition, in the case of the second driving state, the driving control unit 140 does not suppress acceleration of the own vehicle M due to the AP operation, even in a case in which the own vehicle M is accelerated due to the AP operation (the acceleration operation) of the driver, for example, the speed VM of the vehicle M exceeds the speed threshold value (is greater than the speed threshold value). Similarly, even in a case in which the lateral G or the acceleration exceeds the threshold value, acceleration of the own vehicle M is not suppressed. As a result, in a case in which the driver is in the hands-on state, the acceleration can be performed according to the intention of the driver (the AP operation) while the LKAS control is executed. In a case in which the speed VM, the lateral G, or acceleration of the own vehicle M exceeds the threshold value due to the AP operation of the driver in the second driving state, the driving control unit 140 may control the HMI control unit 150 to notify and warn the driver that the speed VM, the lateral G, or acceleration of the own vehicle M has exceeded the threshold value. Furthermore, in a case in which various speed conditions of the first driving state are satisfied, it may be possible to transition the own vehicle from the second driving state to the first driving state.

### In the Case of Transition Condition 3

The condition of transition condition 3 is that, in the first driving state, the AP operation of the driver is detected, the driver is in the hands-off state, and at least one (OR condition) of the conditions (the speed, the lateral G, and the acceleration) in which the speed VM of the own vehicle M is set in the speed conditions shown in FIG. 4 exceeds the threshold value. In a case in which the condition of transition condition 3 is satisfied, the driving control unit 140 transitions the driving state of the own vehicle M from the first driving state to a third driving state. In the case of the third driving state, the driving control unit 140 causes the HMI control unit 150 to output information (hands-on request information) requesting the driver to come into contact with (grip) the steering wheel 82. The HMI control unit 150 generates the hands-on request information for the driver on the basis of the instruction from the driving control unit 140, and causes the generated information to be output from the HMI 30. In addition, in the third driving state, the driving control unit 140 suppresses the acceleration control of the own vehicle M in response to the AP operation of the driver. The suppression of the acceleration control will be described in detail below.

### In the Case of Transition Condition 4

The condition of transition condition 4 is that the driver is in the hands-on state within a first predetermined time after the third driving state is started. In a case in which the condition of transition condition 4 is satisfied, the driving control unit 140 transitions the own vehicle from the third driving state to a fourth driving state. In the case of the fourth driving state, for example, the driving control unit 140 executes the LKAS control while the driver is in the hands-on state, and gradually releases the suppression of the acceleration control executed in the third driving state.

### In the Case of Transition Condition 5

The condition of transition condition 5 is that the suppression of the acceleration control executed in the third driving state is released in the fourth driving state. The suppression of the acceleration control is released when, for example, the speed of the own vehicle M reaches the speed requested through the AP operation of the driver (the opening degree). In a case in which the condition of transition condition 5 is satisfied, the driving control unit 140 transitions the own vehicle from the fourth driving state to the second driving state to execute the driving control.

### In the Case of Transition Condition 6

The condition of transition condition 6 is that the content of the transition condition is not changed even after the first predetermined time has elapsed since the third driving state is started. The “is not changed” means, for example, that the driver is not in the hands-on state. In a case in which the condition of transition condition 6 is satisfied, the driving control unit 140 transitions the own vehicle from the third driving state to a fifth driving state to execute the driving control. In the case of the fifth driving state, the driving control unit 140 controls the HMI control unit 150 to request the hands-on request to the driver more strongly than in the case of the third driving state. The “to request strongly” means to increase the degree of the request, for example, to further output a warning sound in a case in which the notification (the request) is made through image display in the third driving state. In addition, the “to request strongly” may include displaying an image that is more emphasized than the image displayed in the third driving state (for example, an image displayed in an highlighted color, a flashing image, or the like), outputting an alarm different from the alarm output in the third driving state, or outputting a sound that is louder or has a stronger tone than the sound output in the third driving state. In addition, in the fifth driving state, the driving control unit 140 suppresses the acceleration control of the own vehicle M in response to the AP operation of the driver.

### In the Case of Transition Condition 7

The condition of transition condition 7 is that the driver is in the hands-on state within a second predetermined time after the fifth driving state is started. The second predetermined time is, for example, shorter than the first predetermined time. In a case in which the condition of transition condition 7 is satisfied, the driving control unit 140 transitions the own vehicle from the fifth driving state to a sixth driving state to execute the driving control. In the case of the sixth driving state, the driving control unit 140 executes the driving control to switch the driving to manual driving of the driver while gradually releasing the acceleration suppression in the fifth driving state. In other words, in a case in which the driver is in the hands-on state after a predetermined time has elapsed since the fifth driving state is started, control is executed to terminate the driving control performed by the driving control unit 140.

### In the Case of Transition Condition 8

The condition of transition condition 8 is that the suppression of the acceleration control is released in the sixth driving state. In a case in which the condition of transition condition 8 is satisfied, the driving control unit 140 transitions the own vehicle M from the sixth driving state to a seventh driving state. In the case of the seventh driving state, the driving control performed by the driving control unit 140 is terminated, and the own vehicle M travels on the basis of the manual driving of the driver.

### In the Case of Transition Condition 9

The condition of transition condition 9 is that the content of the transition condition is not changed even after the second predetermined time has elapsed since the fifth driving state is started (for example, the driver in not in the hands-on state). In a case in which the condition of transition condition 9 is satisfied, the driving control unit 140 transitions the own vehicle from the fifth driving state to an eighth driving state to execute the driving control. In the case of the eighth driving state, the driving control unit 140 moves the own vehicle M to a safe position (for example, the road shoulder or the like) on the basis of the surrounding situation of the own vehicle M and stops the own vehicle M.

### Acceleration Control in Hands-Off State

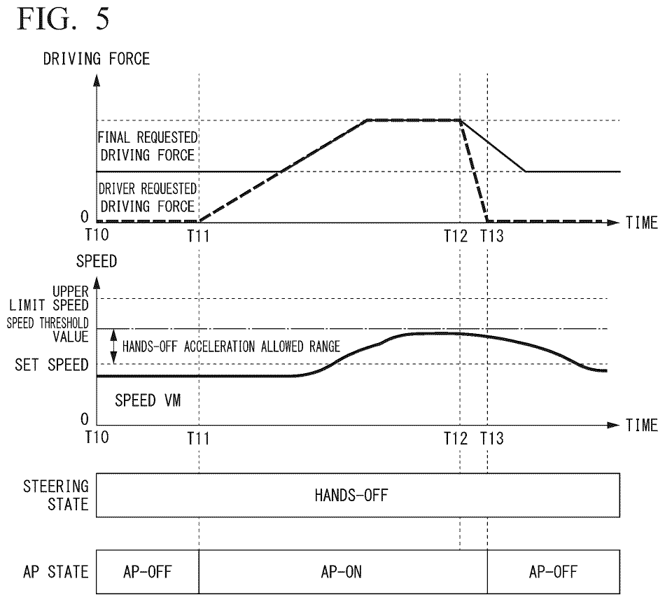

Next, the acceleration control in the hands-off state in the embodiment will be specifically described. FIG. 5 is a diagram for explaining the acceleration control in the hands-off state. The example of FIG. 5 shows the acceleration control in the first driving state. In the example of FIG. 5, the horizontal axis indicates time, and the vertical axes indicate the driving force and the speed VM of the own vehicle M. In the diagram showing the relationship between the time and the driving force, the final requested driving force for the own vehicle M and the driving force requested by the driver through the AP operation (the driver requested driving force) are shown. In addition, in the diagram showing the relationship between the time and the speed, the upper limit speed and set speed obtained when a predetermined driving control (for example, the ACC control) is executed in the hands-off state as the first driving state, the speed threshold value corresponding to the speed condition for transitioning the driving state from the first driving state to the third driving state, and the speed VM of the own vehicle M are shown. The speed threshold value is, for example, an acceleration suppression start speed at which the driving state is transitioned from the first driving state to the third driving state and suppression of the acceleration due to the AP operation is started. In addition, the example of FIG. 5 shows the changes in the driver requested driving force, the final requested driving force, and the speed VM when the AP operation is switched from the AP-off state to the AP-on state in the hands-off state and then is returned to the AP-off state.

In the example of FIG. 5, during the period from time T10 to time T11, the driver does not perform the AP operation (the AP-off state). For this reason, the driving control unit 140 generates the target speed based on the set speed according to the surrounding situation or the like, and controls the final requested driving force such that the generated target speed approaches the speed VM of the own vehicle M, and the speed control based on that driving force is executed. In the driving control unit 140, the target trajectory is generated according to the surrounding situation or the like, and the steering control of the own vehicle is executed such that the own vehicle travels along the generated target trajectory. However, in the following, a portion related to the speed control will be mainly described.

In a case in which the state is in the AP-on state by the AP operation of the driver at time T11, the driving control unit 140 maintains the current speed VM until the driver requested driving force due to the AP operation reaches the current final requested driving force, and when the driver requested driving force exceeds the current final requested driving force, the final requested driving force also increases in accordance with the increase in the driver requested driving force as a result of the acceleration control, and thus the speed VM increases.

Here, the range from the set speed to the speed threshold value shown in FIG. 5 is a range in which the acceleration in the hands-off state is allowed (an acceleration allowed range). The driving control unit 140 can increase the speed VM within the acceleration allowed range in response to an increase in the driver requested driving force. In addition, in a case in which the driver requested driving force decreases during the period from time T12 to time T13 (in a case in which the accelerator opening becomes smaller), the driving control unit 140 adjusts the amount of reduction in the final requested driving force such that the deceleration amount of the own vehicle M does not exceed a predetermined amount. Furthermore, in a case in which the state is in the AP-off state at time T13, the driving control unit 140 controls the speed VM of the own vehicle M such that it gradually approaches the target speed based on the set speed. As shown in FIG. 5, by permitting acceleration within a range that does not exceed the speed threshold value even in the hands-off state, the driving assistance in the first driving state can be continued. Therefore, in a case in which it is desired to temporarily accelerate in order to shift a position with respect to a parallel-traveling vehicle as shown in FIG. 2, it is not necessary to be in the hands-on state, and appropriate driving control can be executed while improving the operability of the driver.

### Suppression of Acceleration Control

In the example of FIG. 5, in a case in which the speed VM of the own vehicle M exceeds the speed threshold value through the AP operation (the acceleration operation) of the driver (in a case in which the speed VM is greater than the speed threshold value), the driving control unit 140 transitions the driving state of the own vehicle M from the first driving state to the third driving state. In a case in which the vehicle transitions to the third driving state, the driving control unit 140 suppresses the acceleration control due to the AP operation of the driver. In this case, the driving control unit 140 does not increase the speed VM even in a case in which the driver requested driving force increases due to the AP operation. As a result, it is possible to suppress excessive acceleration in the hands-off state. In addition, in the third driving state, by notifying the driver of the hands-on request, it is possible to transition the driving state to the second driving state and to permit further acceleration on the condition of the hands-on. As a result, it is possible to execute more appropriate driving control according to the driving situation. In addition, in a case in which the driver is not in the hands-on state even after the first predetermined time has elapsed from the third driving state, the driving control unit 140 transitions the driving state of the own vehicle M from the third driving state to the fifth driving state, but the acceleration control in the hands-off state is also suppressed in the fifth driving state.

Here, the speed threshold value, the lateral G threshold value, and the acceleration threshold value included in the above-mentioned speed conditions may be variably set according to the set speed (or the target speed) and the road shape when the driving control such as the ACC is executed, for example. For example, in a case in which the road shape on which the own vehicle M travels is a straight line, the driving control unit 140 permits acceleration in the first driving state until the speed VM of the own vehicle M is less than or equal to the maximum speed threshold value up to which the first driving state can be continued, and in a case in which the speed VM of the own vehicle M is greater than (exceeds) the maximum speed threshold value, the driving control unit 140 transitions the driving state to the third driving state, suppresses the acceleration control, and outputs the hands-on request. In a case in which the set speed (or the target speed) is less than the maximum speed threshold value by a certain amount, the speed threshold value may be changed to a smaller value. In this case, the speed threshold value is, for example, a value obtained by adding a predetermined additional speed to the set speed. In this way, by adjusting the speed threshold value in accordance with the set speed, excessive acceleration in the hands-off state can be suppressed, and thus it is possible to realize safer driving control.

In addition, in a case in which the road on which the own vehicle M travels is a curved road, the speed threshold value may be adjusted, for example, according to the set speed and the magnitude of the radius of curvature (or the curvature is also possible) of the road. In this case, when the own vehicle travels on the curved road, a speed that does not exceed the lateral G threshold value (the upper lateral acceleration limit value) (for example, 0.1 to 0.15 [G]) at which the driving control in the first driving state is permitted is set as the speed threshold value. For example, the smaller the radius of curvature is, the smaller the speed threshold value corresponding to the set speed is set so as not to exceed the lateral G threshold value. In this way, by adjusting the speed threshold value on the basis of the set speed and the road shape, it is possible to transition the driving state at more appropriate timing according to the vehicle situation and the surrounding situation. For this reason, it is possible to realize more appropriate driving control in the hands-off state.

In addition, the driving control unit 140 may adjust the acceleration threshold value (the allowable acceleration) according to the speed VM of the own vehicle M to prevent the behavior of the own vehicle M from becoming unstable due to sudden acceleration. The acceleration threshold value may be stored, for example, in the storage unit 160, or may be acquired from an external device via the communication device 20.

For example, as the acceleration threshold value, when the speed VM of the own vehicle M is in a low speed region, a first acceleration threshold value is set, when the speed VM is in a medium speed region, a second acceleration threshold value smaller than the first acceleration threshold value is set, and when the speed VM is in a high speed region, a third acceleration threshold value smaller than the first acceleration threshold is set. The third acceleration threshold value may be set such that the third acceleration threshold value is gradually decreased as the speed VM increases. In this case, a predetermined speed in the high speed region may be set to a constant acceleration threshold value. In this way, by setting the acceleration threshold value to a constant value in a case in which the own vehicle M travels at a speed greater than a predetermined speed, a certain degree of acceleration can be allowed even if the vehicle speed increases.

The acceleration threshold value indicates a different condition from the speed threshold value, but may be adjusted in accordance with the speed threshold value. In this way, by making it possible to adjust the conditions (the speed threshold value, the lateral G threshold value, and the acceleration threshold value) for transitioning the driving state according to the situation of the own vehicle M and the surrounding situation, it is possible to realize more appropriate driving control.

By setting the allowable acceleration threshold value to a higher value as the speed of the own vehicle M becomes lower, the region in which the driving assistance can be continued during the AP operation can be expanded within an appropriate range. In this way, by adjusting the allowable acceleration according to a margin value in the driving assistance, the speed control according to the intention of the driver is possible even in the hands-off state, thereby improving driver operability.

### Transition of Driving State Before and After Traveling on Curved Road

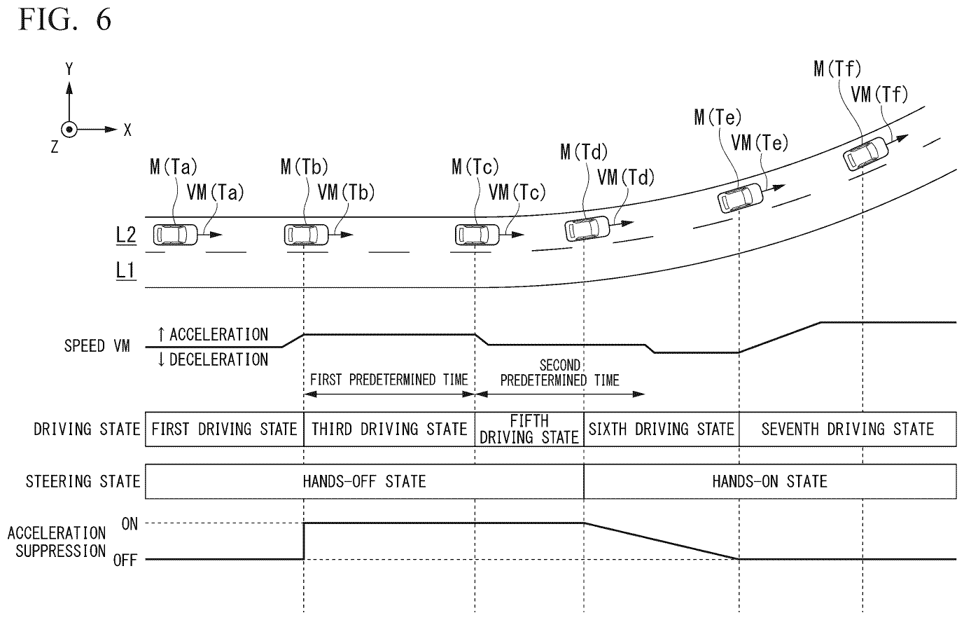

Next, an example of the transition of the driving state before and after the own vehicle M travels on the curved road will be described. FIG. 6 is a diagram for explaining the transition of the driving state when traveling near the curved road. FIG. 6 shows an example in which the own vehicle M is traveling on a lane L2 at a speed VM among two lanes L1 and L2 in which the own vehicle M can travel in the same direction. In addition, in the example of FIG. 6, at time T*, the reference position (for example, the center of gravity position) of the own vehicle M is represented as M (T*), the speed of the own vehicle M is represented as VM (T*), with time Ta being the earliest, followed by times Tb, Tc, Td, Te, and Tf in that order. In addition, the example of FIG. 6 shows aspects of changes of the speed VM, the driving state, the steering state, and the acceleration suppression (on/off) of the own vehicle M over time.

In the example of FIG. 6, the recognition unit 110 recognizes the radius of curvature (or the curvature) of the road in the traveling direction of the own vehicle M from the map information or the like. In addition, the recognition unit 110 may recognize the radius of curvature (or the curvature) of the lane L2 (or the road) on which the own vehicle M travels on the basis of output information from the external environment detection device such as the camera 10, instead of (or in addition to) the map information. For example, in a case in which the own vehicle M travels at a position that is a predetermined distance or more before the curved road, the recognition unit 110 recognizes information about the curved road ahead (for example, the radius of curvature) from the map information. In addition, in a case in which the own vehicle M travels on the curved road, the recognition unit 110 recognizes information about the curved road ahead obtained from the output information from the external environment detection device mounted on the own vehicle M. The driving control unit 140 generates a target speed on the basis of the recognized information of the curved road. In this way, since the recognition accuracy of the external environment detection device decreases before entering the curved road, the target vehicle speed is generated using the information about the curved road obtained from map information, and after entering the curved road, the target vehicle speed is set from the traveling state obtained from the external environment detection device of the own vehicle M, and thus it is possible to execute more appropriate driving control in accordance with the traveling state perceived by the occupant. In addition, the driving control unit 140 may generate the target trajectory in addition to the target speed.

At time Ta, it is assumed that the own vehicle M executes the driving control in the first driving state (for example, the ACC control in the hands-off state). In this case, since the AP operation of the driver is not detected, the driving control unit 140 executes constant speed driving at the target speed (and the target trajectory) according to a preset set vehicle speed for straight-line driving. Here, it is assumed that the driver executes the AP operation before time Tb and transition condition 3 is satisfied at time Tb. In this case, the driving control unit 140 transitions the driving state of the own vehicle M from the first driving state to the third driving state. In the third driving state, a request for the driver to be hands-on is output, and the acceleration control in response to the AP operation is suppressed. At this point in time, the own vehicle M executes constant speed traveling at a speed with the acceleration suppressed.

In a case in which there is a curved road ahead of the own vehicle M (within a predetermined distance), the driving control unit 140 may control the transition to the third driving state earlier than in a case in which the road ahead is a straight line. In this case, the driving control unit 140 sets the speed threshold value to be smaller than in a case in which a straight line is present ahead, for example. In addition, the driving control unit 140 may set the lateral G threshold value to a small value, and may set the acceleration threshold value to a small value.

Next, at time Tc when the first predetermined time has elapsed while the own vehicle remains in the third driving state, the driving control unit 140 transitions the driving state of the own vehicle M from the third driving state to the fifth driving state. In the fifth driving state, an even stronger hands-on request is output, and the suppression of the acceleration control continues. At time Tc, the own vehicle M starts traveling on the curved road, and thus the own vehicle M travels at a slower speed than when traveling on the straight road, according to the set speed corresponding to the curved road.

Next, in a case in which the driver is in the hands-on state at time Td before the second predetermined time has elapsed since the fifth driving state is started, the driving control unit 140 transitions the driving state of the own vehicle M from the fifth driving state to the sixth driving state. In the sixth driving state, the acceleration suppression is gradually released and the traveling control due to the manual driving operation is reflected, and thus in a case in which the deceleration driving is performed by the braking operation, the speed VM of the own vehicle M will decrease as shown in FIG. 6.

In addition, at time Te when the suppression of the acceleration control is terminated (released), the driving control unit 140 transitions the driving state of the own vehicle M from the sixth driving state to the seventh driving state. In the seventh driving state, only the manual driving is executed, and thus the steering and the speed of the own vehicle M are controlled according to the driving operation of the driver. In addition, in the seventh driving state, the driving control unit 140 can transition the driving state from the seventh driving state back to the first driving state by receiving an instruction to switch the driving state from the driver or the like.

In this way, by transitioning the driving state on the basis of the transition conditions described above even in a case in which the own vehicle travels near the curved road, it is possible to execute more appropriate driving control according to the surrounding situation.

### Processing Flow

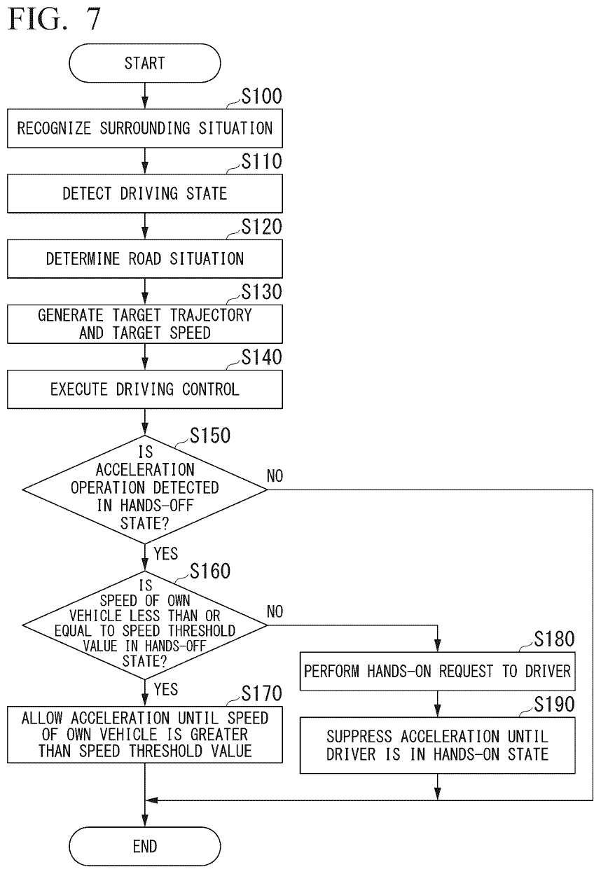

FIG. 7 is a flowchart showing an example of processing executed by the driving assistance device 100 according to the embodiment. In the example of FIG. 7, driving control processing including acceleration control processing by the AP operation in the driving control mainly in the hands-off state among pieces of processing executed by the driving assistance device 100 will be mainly described. In addition, the following processing may be repeatedly executed at a predetermined interval or at a predetermined timing.

In the example of FIG. 7, the recognition unit 110 recognizes the surrounding situation of the own vehicle M (step S100). Next, the driving state detection unit 120 detects the driving state of the own vehicle M or the driver (step S110). The driving state includes, for example, the hands-on state, the hands-off state, and the acceleration operation or the steering operation of the own vehicle M by the driver. Next, the road situation determination unit 130 determines the road situation in the traveling direction of the own vehicle M (step S120). In the processing of step S120, the road situation determination unit 130 determines, for example, whether or not the road in the traveling direction of the own vehicle M is a curved road (a straight road).

Next, the driving control unit 140 generates a target trajectory and a target speed for the own vehicle M on the basis of the surrounding situation and the road situation (step S130), and executes the driving control on the basis of the generated target trajectory and target speed (step S140). Next, the driving control unit 140 determines whether or not the acceleration operation (the AP operation) is detected in the hands-off state of the driver (a state in which the driver is not in contact with the steering operator (the steering wheel 82)) (step S150). In a case in which it is determined that the acceleration operation is detected, the driving control unit 140 determines whether or not the speed VM of the own vehicle M is less than or equal to the speed threshold value in the hands-off state (step S160).

In a case in which it is determined that the speed of the own vehicle M is less than or equal to the speed threshold value in the hands-off state, the driving control unit 140 allows acceleration through the acceleration operation until the speed of the own vehicle M is greater than the speed threshold value (step S170). In addition, in a case in which, in the processing of step S160, it is determined that the speed of the own vehicle M is not equal to or less the speed threshold value in the hands-off state, the driving control unit 140 performs the hands-on request to the driver (step S180) and suppresses acceleration until the driver is in the hands-on state (step S190). As a result, the instruction in the present flowchart is terminated. In addition, in a case in which it is determined in the processing of step S150 that the acceleration operation is not detected in the hands-off state of the driver, the processing of the present flowchart is terminated.

In the processing of step S160 shown in FIG. 7, it may be determined whether or not the lateral G of the own vehicle M is less than or equal to the lateral G threshold value, or whether or not acceleration of the own vehicle M is less than or equal to the acceleration threshold value, instead of (or in addition to) the speed threshold value. In this case, in the processing of step S170, the driving control unit 140 permits acceleration until the lateral G or acceleration of the own vehicle M is greater than the corresponding threshold value.

### Modification Example

In the embodiment, permission, suppression, or the like of acceleration of the own vehicle M due to the acceleration operation of the driver may be performed using the acceleration threshold value or the lateral G threshold value, instead of (or in addition to) the speed threshold value. For example, the driving control unit 140 permits acceleration of the own vehicle due to the acceleration operation of the driver in a case in which acceleration of the own vehicle M due to the acceleration operation of the driver is less than or equal to the acceleration threshold value, and suppresses acceleration of the own vehicle M due to the acceleration operation of the driver and performs the hands-on request to the driver in a case in which acceleration of the own vehicle M due to the acceleration operation of the driver is not equal to or less the acceleration threshold value. In addition, the driving control unit 140 permits acceleration of the own vehicle M due to the acceleration operation of the driver in a case in which the lateral G of the own vehicle M due to the acceleration operation of the driver is less than or equal to the lateral G acceleration threshold value, and suppresses acceleration of the own vehicle M due to the acceleration operation of the driver and performs the hands-on request to the driver in a case in which the lateral G of the own vehicle M due to the acceleration operation of the driver is not equal to or less the lateral G acceleration threshold value.

In addition, the speed condition included in the conditions for determining whether or not to transition the driving state in the embodiment may be different between the case in which the driver is in the hands-on state and the case in which the driver is in the hands-off state. For example, as a case in which the speed threshold value included in the speed condition includes a first speed threshold value for the hands-on state and a second speed threshold value for the hands-off state, in a case in which the driver perform the acceleration operation in the hands-off state (in a case in which the acceleration operation is detected), the driving control unit 140 permits acceleration of the own vehicle M until the speed VM of the own vehicle M is greater than the second speed threshold value in a case in which the speed VM of the own vehicle M is less than or equal to the second speed threshold value, and suppresses acceleration of the own vehicle M and performs the hands-on request to the driver until the driver is in the hands-on state in a case in which the speed VM of the own vehicle M is greater than the second speed threshold value.

According to the embodiment described above, a non-transitory storage medium stores computer-readable instructions to be executed by a computer, and the instructions include recognizing the surrounding situation of the own vehicle M, detecting the acceleration operation of the own vehicle by the driver of the own vehicle M, detecting contact of the driver with the steering operator that performs the steering operation of the own vehicle M, generating the target trajectory and the target speed of the own vehicle M on the basis of the surrounding situation, and executing the driving control based on the steering control of the own vehicle M with respect to the generated target trajectory and the speed control of the own vehicle M with respect to the generated target speed. The driving control includes a driving state in which the driver needs to be in contact with the steering operator and a driving state in which the driver does not need to be in contact with the steering operator. The instructions further include permitting acceleration of the own vehicle M in the driving state until the speed of the own vehicle is greater than the speed threshold value in a case in which the driving state is a driving state in which the driver does not need to be in contact with the steering operator, the acceleration operation of the driver is detected, and the speed of the own vehicle M is less than or equal to the speed threshold value, and suppressing acceleration of the own vehicle M and requesting the driver to come into contact with the steering operator until contact of the driver with the steering operator is detected in a case in which the driving state is a driving state in which the driver does not need to be in contact with the steering operator, the acceleration operation of the driver is detected, and the speed of the own vehicle M is greater than the speed threshold value. Through such processing, it is possible to perform more appropriate driving control according to the driving situation of the driver and the situation of the vehicle.

For example, according to the embodiment, in the driving controls such as ACC and LKAS, the acceleration through the driver's request is permitted up to the acceleration request (or the driving force) that can guarantee safety in the hands-off state, and in a case in which the acceleration request exceeds the acceleration that can guarantee the safety, the vehicle is driven with a limited driving force to suppress the acceleration and the hands-on request is performed. As a result, acceleration of the own vehicle M due to the acceleration operation is allowed even in the hands-off state, and thus thereby reducing the operational burden on the driver in a case in which the temporary acceleration, such as to shift a position with respect to the parallel-traveling vehicle, is performed, and improving convenience for the driver. In addition, by allowing the acceleration driving within a range in which the driving control can be continued in the hands-off state, the driving intention of the driver can be appropriately determined, and more appropriate driving control can be realized.

In addition, according to the embodiment, by detecting the hands-on state of the driver during the acceleration suppression, the driving control in the hands-on state can be continued. In addition, according to the embodiment, in a case in which the vehicle travels on the curved road at the target vehicle speed in the hands-off state, a determination is made as to whether or not to permit the acceleration on the basis of the speed threshold value corresponding to the curved road, or whether or not to suppress the acceleration and perform the hands-on request, and thus it is possible to realize more appropriate driving control according to the surrounding situation of the own vehicle M.

In addition, according to the embodiment, the acceleration threshold value is adjusted according to the speed of the own vehicle M, and a determination is made as to whether or not to permit the acceleration due to the acceleration operation of the driver, or whether or not to suppress the acceleration and perform the hands-on request, and thus it is possible to realize the driving control that more accurately reflects the driving intention of the driver.

The embodiment described above can be expressed as follows.

A vehicle control device including:
a storage medium storing computer-readable instructions; and
a processor connected to the storage medium,
the processor executing the computer-readable instructions to:
recognize a surrounding situation of an own vehicle;
detect an acceleration operation of the own vehicle performed by a driver of the own vehicle;
detect contact of the driver with a steering operator that performs a steering operation of the own vehicle;
generate a target trajectory and a target speed of the own vehicle on the basis of the surrounding situation; and
execute driving control based on steering control of the own vehicle with respect to the generated target trajectory and speed control of the own vehicle with respect to the generated target speed,
wherein the driving control includes a driving state in which the driver needs to be in contact with the steering operator and a driving state in which the driver does not need to be in contact with the steering operator, and
wherein, in a case in which the acceleration operation of the driver is detected in the driving state in which the driver does not need to be in contact with the steering operator,
acceleration of the own vehicle in the driving state is permitted until the speed of the own vehicle is greater than the speed threshold value in a case in which the speed of the own vehicle is less than or equal to the speed threshold value, and
acceleration of the own vehicle is suppressed and the driver is requested to come into contact with the steering operator until contact of the driver with the steering operator is detected in a case in which the speed of the own vehicle is greater than the speed threshold value.

Although forms for carrying out the present invention have been described above using the embodiments, the present invention is not limited to these embodiments, and various modifications and substitutions can be made without departing from the gist of the present invention.

What is claimed is:

1. A non-transitory storage medium storing computer-readable instructions for causing a computer to execute the instructions, the instructions comprising:
recognizing a surrounding situation of an own vehicle;
detecting an acceleration operation of the own vehicle performed by a driver of the own vehicle;
detecting contact of the driver with a steering operator that performs a steering operation of the own vehicle;
generating a target trajectory and a target speed of the own vehicle on the basis of the surrounding situation; and
executing driving control based on steering control of the own vehicle with respect to the generated target trajectory and speed control of the own vehicle with respect to the generated target speed,
wherein the driving control includes a driving state in which the driver needs to be in contact with the steering operator and a driving state in which the driver does not need to be in contact with the steering operator, and
wherein the instructions further comprise:
permitting acceleration of the own vehicle in the driving state until a speed of the own vehicle is greater than a speed threshold value in a case in which the driving state is a driving state in which the driver does not need to be in contact with the steering operator, the acceleration operation of the driver is detected, and the speed of the own vehicle is less than or equal to the speed threshold value; and
suppressing acceleration of the own vehicle and requesting the driver to come into contact with the steering operator until contact of the driver with the steering operator is detected in a case in which the driving state is a driving state in which the driver does not need to be in contact with the steering operator, the acceleration operation of the driver is detected, and the speed of the own vehicle is greater than the speed threshold value.

2. The storage medium according to claim 1, wherein the instructions further comprise executing the driving control in the driving state in which the driver needs to be in contact with the steering operator in a case in which contact of the driver with the steering operator is detected within a predetermined time after the driver is requested to come into contact with the steering operator.

3. The storage medium according to claim 2, wherein the instructions further comprise terminating the driving control in a case in which contact of the driver with the steering operator is detected after the predetermined time has elapsed.

4. The storage medium according to claim 1, wherein the instructions further comprise:
permitting acceleration of the own vehicle due to the acceleration operation of the driver in a case in which acceleration of the own vehicle due to the acceleration operation of the driver is less than or equal to an acceleration threshold value; and
suppressing acceleration of the own vehicle due to the acceleration operation of the driver and requesting the driver to come into contact with the steering operator in a case in which acceleration of the own vehicle due to the acceleration operation of the driver is not less than or equal to the acceleration threshold value.

5. The storage medium according to claim 4, wherein the acceleration threshold value is set to a smaller value as the speed of the own vehicle increases.

6. The storage medium according to claim 4, wherein the acceleration threshold value is set to a constant value in a case in which the speed of the own vehicle is greater than a predetermined speed.

7. The storage medium according to claim 1, wherein the instructions further comprise making the speed threshold value different between a case in which the own vehicle travels on a curved road and a case in which the own vehicle does not travel on the curved road.

8. The storage medium according to claim 7, wherein, in a case in which the own vehicle travels on the curved road, the speed threshold value is set to a speed that does not exceed a lateral acceleration upper limit value.

9. The storage medium according to claim 1, wherein the instructions further comprise:
accelerating the own vehicle due to the acceleration operation of the driver in a case in which contact of the driver with the steering operator is detected; and
not suppressing acceleration of the own vehicle even in a case in which the speed of the own vehicle is greater than the speed threshold value.

10. The storage medium according to claim 7, wherein the instructions further comprise generating the target speed on the basis of information about the curved road obtained from map information in a case in which the own vehicle travels at a position that is a predetermined distance or more before the curved road.

11. The storage medium according to claim 7, wherein the instructions further comprise generating the target speed on the basis of information about the curved road obtained from output information from an external environment detection device mounted on the own vehicle in a case in which the own vehicle travels on the curved road.

12. The storage medium according to claim 1,
wherein the speed threshold value includes a first speed threshold value in a case in which the driver is in contact with the steering operator and a second speed threshold value in a case in which the driver is not in contact with the steering operator, and
wherein the instructions further comprise:
permitting acceleration of the own vehicle in the driving state until the speed of the own vehicle is greater than the second speed threshold value in a case in which the driving state is a driving state in which the driver does not need to be in contact with the steering operator, the acceleration operation of the driver is detected, and the speed of the own vehicle is less than or equal to the second speed threshold value; and
suppressing acceleration of the own vehicle and requesting the driver to come into contact with the steering operator until contact of the driver with the steering operator is detected in a case in which the driving state is a driving state in which the driver does not need to be in contact with the steering operator, the acceleration operation of the driver is detected, and the speed of the own vehicle is greater than the second speed threshold value.

13. A vehicle control device comprising:
a recognition unit that recognizes a surrounding situation of an own vehicle;
an acceleration detection unit that detects an acceleration operation of the own vehicle performed by a driver of the own vehicle;
a steering detection unit that detects contact of the driver with a steering operator that performs a steering operation of the own vehicle; and
a driving control unit that generates a target trajectory and a target speed of the own vehicle on the basis of the surrounding situation, and executes driving control based on steering control of the own vehicle with respect to the generated target trajectory and speed control of the own vehicle with respect to the generated target speed,
wherein the driving control includes a driving state in which the driver needs to be in contact with the steering operator and a driving state in which the driver does not need to be in contact with the steering operator,
wherein the driving control unit permits acceleration of the own vehicle in the driving state until a speed of the own vehicle is greater than a speed threshold value in a case in which the driving state is a driving state in which the driver does not need to be in contact with the steering operator, the acceleration operation of the driver is detected by the acceleration detection unit, and the speed of the own vehicle is less than or equal to the speed threshold value, and
wherein the driving control unit suppresses acceleration of the own vehicle and requests the driver to come into contact with the steering operator until contact of the driver with the steering operator is detected in a case in which the driving state is a driving state in which the driver does not need to be in contact with the steering operator, the acceleration operation of the driver is detected by the acceleration detection unit, and the speed of the own vehicle is greater than the speed threshold value.

14. A vehicle control method causing a computer to:
recognize a surrounding situation of an own vehicle;
detect an acceleration operation of the own vehicle performed by a driver of the own vehicle;
detect contact of the driver with a steering operator that performs a steering operation of the own vehicle;
generate a target trajectory and a target speed of the own vehicle on the basis of the surrounding situation; and
execute driving control based on steering control of the own vehicle with respect to the generated target trajectory and speed control of the own vehicle with respect to the generated target speed,
wherein the driving control includes a driving state in which the driver needs to be in contact with the steering operator and a driving state in which the driver does not need to be in contact with the steering operator, and
wherein the method causes the computer further to:
permit acceleration of the own vehicle in the driving state until a speed of the own vehicle is greater than a speed threshold value in a case in which the driving state is a driving state in which the driver does not need to be in contact with the steering operator, the acceleration operation of the driver is detected, and the speed of the own vehicle is less than or equal to the speed threshold value; and
suppress acceleration of the own vehicle and request the driver to come into contact with the steering operator until contact of the driver with the steering operator is detected in a case in which the driving state is a driving state in which the driver does not need to be in contact with the steering operator, the acceleration operation of the driver is detected, and
the speed of the own vehicle is greater than the speed threshold value.
